(19) United States
(12) Patent Application Publication
(10) Pub. No.: US 2002/0010656 A1
(43) Pub. Date: Jan. 24, 2002

(54) Link engine computer and method

(76) Inventor: Daniel M. Suib, Brookfield, CT (US)

Correspondence Address: Paul D. Greeley, Esq., Ohlandt, Greeley, Ruggiero & Perle, L.L.P., 10th Floor, One Landmark Square, Stamford, CT, 06901-2682, US

(21) Appl. No.: 09/872,751

(22) Filed: Jun. 1, 2001

Related U.S. Application Data
(60) Provisional application No. 60/208,463, filed on Jun. 1, 2000.
(60) Provisional application No. 60/282,829, filed on Apr. 10, 2001.

(51) Int. Cl. G06F 17/60; G06F 17/00

(52) U.S. Cl. 705/27

(57) ABSTRACT

A method and computer for searching the Internet or World Wide Web for a vendor and/or source of products. The method employs an interactive session with the user and initially presents a web page with a selection mechanism that allows the user to identify a product. When the user identifies the product, logos of companies that offer the products are presented to the user. When the user selects one of the logos, a list of vendors is presented to the user. URLs are embedded in the list to hot link the user to a web site or page of a selected vendor. The logo grouping and vendor list is limited to a predetermined territory. The predetermined territory can be defined in terms of the user's zip code or by user entry of a country, state and county or other political divisions.

This Application claims the benefit of U.S. Provisional Application No. 60/208,463, filed Jun. 1, 2000 and U.S. Provisional Application No. 60/282,829 filed Apr. 10, 2001.

### BACKGROUND OF THE INVENTION

1. Field of the Invention

This invention relates to a computer and method for locating an item on the Internet or World Wide Web.

2. Description of the Prior Art

Current search engines present a user with a search process that is confusing as well as tedious and cumbersome. The search process confronts the user with the task of selecting a category from huge libraries of categories. The names given to the categories often overlap with one another, resulting in an enormous number of matches.

Current search engines also provide keyword searching features. Keyword searching gives the user the ability to look for topics that include a common word within that topic. Unfortunately, with over 8 million web sites, words become common in several different topics that give the user matches in topics that are entirely irrelevant. For example, the word “furniture” takes the user to 20 categories with over 27,000 possible web sites. By narrowing the search down to couches, four topics come up with the word couches in them and 17 categories come up dealing with ceramics. The end result is that keyword searching frequently results in an unmanageable number of matches. The names given to the categories or topics in the search engine libraries may not include the words that the user uses to describe the item being searched, thereby resulting in no matches or in matches that are entirely irrelevant.

What is needed is a streamlined search engine that is less time consuming and that has a high percentage of successful searches for novices as well as skilled searchers.

### SUMMARY OF THE INVENTION

The method of the present invention searches for a vendor or a source of goods or services (products) that a user desires to procure either information thereon or the products themselves. According to the method, a session with a user begins with presenting a web page that includes a selection mechanism for identifying a product. When the user identifies a product, a plurality of logos or brands of sources that offer the identified product are presented to the user for selection. When one of the logos is selected, a list of vendors that deal in the identified product and selected logo is presented to the user. At least one of the vendors has a web site or web page that is hot-linked via a URL embedded in the list. The method of the invention permits the user to reach a vendor of a desired brand of products in a minimum of two or three selections or mouse clicks.

The method also provides a drill down capability in which the user first identifies a category of products, then a sub-category of products and so on. The logo and vendor list presentations are made when the category level matches the desired product.

The selection mechanism also identifies a predetermined territory, in which the vendors are located. In one embodiment of the method, the predetermined territory is defined as an area of a zip code that has an extended border. In another embodiment of the method, the predetermined territory is defined by country, state and county. The computer of the present invention performs the method of the invention.

### BRIEF DESCRIPTION OF THE DRAWING

Other and further objects, advantages and features of the present invention will be understood by reference to the following specification in conjunction with the accompanying drawings, in which like reference characters denote like elements of structure and:

FIG. 1 is a diagram of a system in which the method of the present invention can be used;

FIG. 2 is a block diagram of an application server according to the present invention;

FIG. 3 depicts a data structure for the logo search program of the FIG. 2 application server;

FIG. 4 depicts a category web page presented by the logo search program of the FIG. 2 application server;

FIG. 5 depicts a sub-category web page presented by the logo search program of the FIG. 2 application server;

FIG. 6 depicts a logo web page for a selected sub-category that is presented by the logo search program of the FIG. 2 application server;

FIG. 7 depicts a portion of the category web page of FIG. 4 with a user selection of a state;

FIG. 8 depicts a county web page presented by the logo search program of the FIG. 2 application server;

FIGS. 9 and 10 are flow diagrams of the logo search program of the FIG. 2 application server; and

FIG. 11 is a diagram of another system in which the method of the present invention can be used;

FIGS. 12-14 depict web pages used by the system of FIG. 11;

FIG. 15 depicts a data structure for the logo search program of the FIG. 11 system; and

FIGS. 16 and 17 are flow diagrams of the logo search program of the FIG. 11 system.

### DESCRIPTION OF THE INVENTION

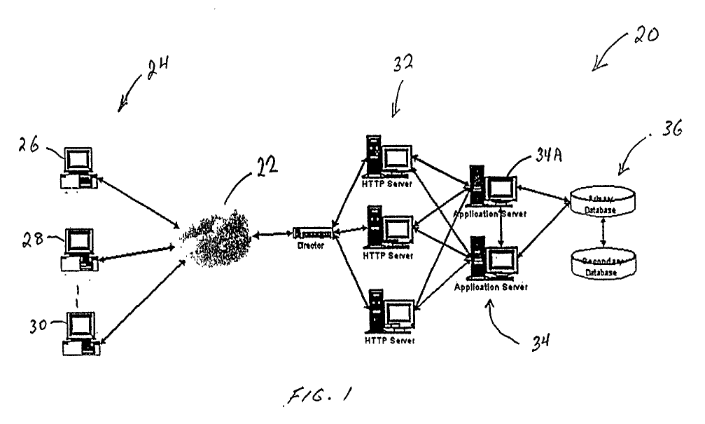

Referring to FIG. 1, a web page server system 20 communicates with a plurality of user devices 24 via an Internet 22. User devices 24 may be any suitable device upon which a browser may run, such as a personal computer, a telephone, a television set, a hand held computing device and the like. It will be appreciated by those skilled in the art that the number of user devices is limited only by the capacity of the Internet and the worldwide web. By way of example, three user devices 26, 28 and 30 are shown with a dashed line from user device 28 to user device 30 illustrates this capacity.

Web page server system 20 includes a plurality of HTTP servers 32, one or more application servers 34 and a database 36. HTTP servers 32 may be any suitable server, presently known or developed in the future, that is capable of communicating via internet 22 with web clients 24 in a protocol that is compatible with the browser capability of web clients 24. Application servers 34 may be any suitable server, presently known or developed in the future, that is capable of running applications that supply web page data to HTTP servers 32 and interact with web page actions taken by web clients 24. Database 36 may be any suitable database, presently known or developed in the future, that is capable of handling large amounts of data.

Application servers 34 present web pages that are served by HTTP servers via Internet 22 to one of user devices 24 during a session. The web pages, if frequently served, may reside in a cache memory of application servers 34 or in database 36.

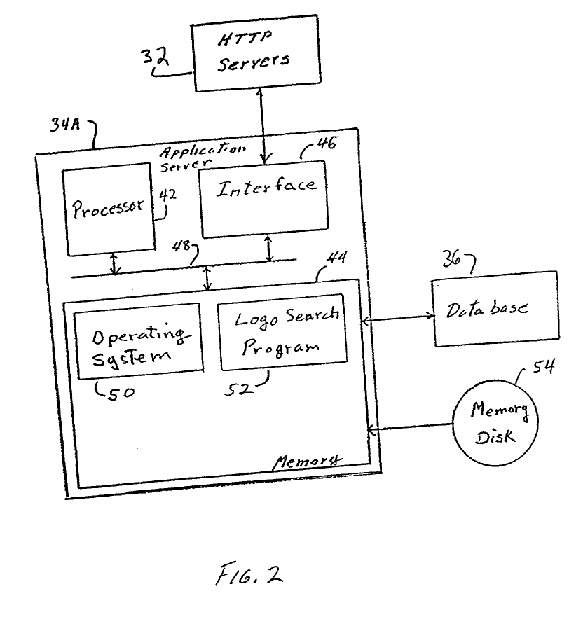

Application servers 34 may be substantially identical in architecture. For example, application server 34A is shown in FIG. 2 to include a processor 42, an interface 46 and a memory 44 that are interconnected via a bus 48. Memory 44 includes an operating system 50 and a logo search program 52 of the present invention. Other programs, such as utilities and other applications, may also be stored in memory 44. All of these programs may be loaded into memory 44 from a memory medium, such as a memory disk 54.

Processor 42 is operable under the control of operating system 50 to execute logo search program 52 to present web pages via interface 46 to HTTP servers 32 for presentation to user devices 24 during a session and to receive and interact with responses from user devices 24. The web pages, if frequently served, may reside in a cache (not shown) of memory 44 or in database 36.

It will be apparent to those skilled in the art that logo search program 52 may alternatively be distributed among application server 34A and the other application servers 34, database 36 or other computers. The physical locations of HTTP servers 32, application servers 34 or database 36 are unimportant to the present invention. They may be in the same physical location or in separate locations that communicate via Internet 22 or other communication facility.

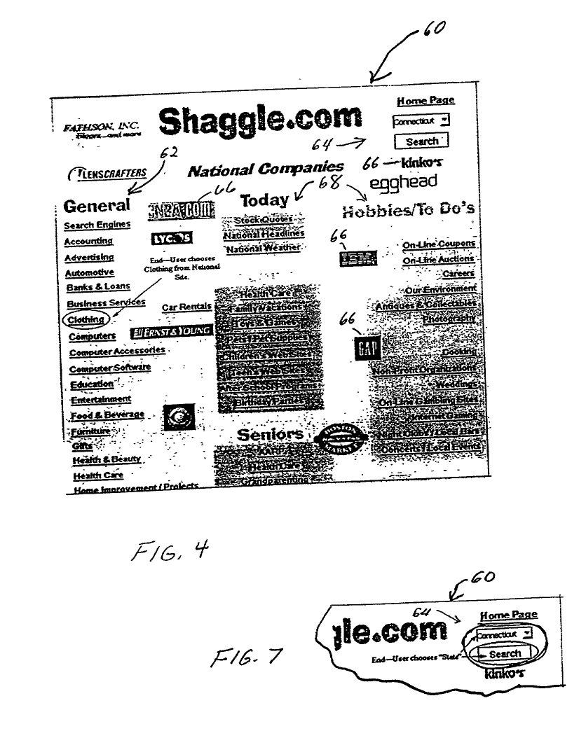

Logo search program 52 will initially be described based on a typical session with a user device, for example, user device 26 of FIG. 1. With reference, to FIG. 4, a category page 60 is presented to user device 26. Category page 60 includes a generic list 62 of generic items for selection by user device 26, a geographical selector 64, a group of logos 66 and other items 68 that are not germane to the present invention. According to the present invention, user device 26 may be hot-linked to a web site of a source or a vendor of products denoted by logos 66. It will be appreciated that the method of the invention is useful to locate a source or vendor of goods or of services. The term “product” is used herein to denote either a good, a service or a combination thereof.

A user at this point has the choice of searching either by selecting a category from generic list 62 or by selecting one of logos 66. For example, the user may be interested in clothing. Remembering that a GAP store is nearby, the user can select the GAP logo and be hot-linked to the web site of GAP Company, Inc. However, logos appearing on category page 60 are generally nationally known brands that are vendors or manufacturers of a broad line of products for one or more of generic categories 62. For this reason, logos 66 on page 60 will be hot-linked to a web site or page of the corporation itself, requiring further drilling through pages at that web site to reach a desired item of interest.

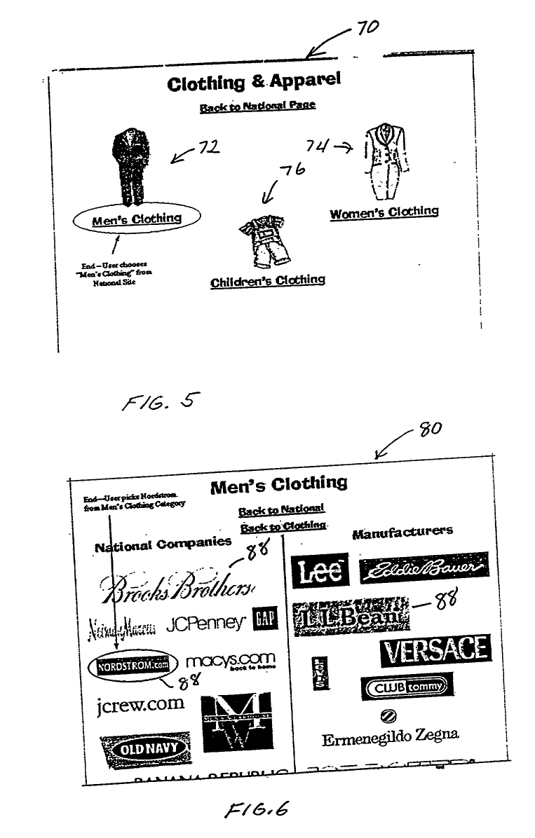

If the user selects the category of clothing from generic category list 62, a sub-category web page 70, shown in FIG. 5, is presented to user device 26. Sub-category web page 70 includes sub-categories, men's clothing 72, women's clothing 74 and children's clothing 76. Although only three subcategories are shown, it will be apparent to those skilled in the art that more sub-categories are possible. Also, if desired, logos could be located on web page 70.

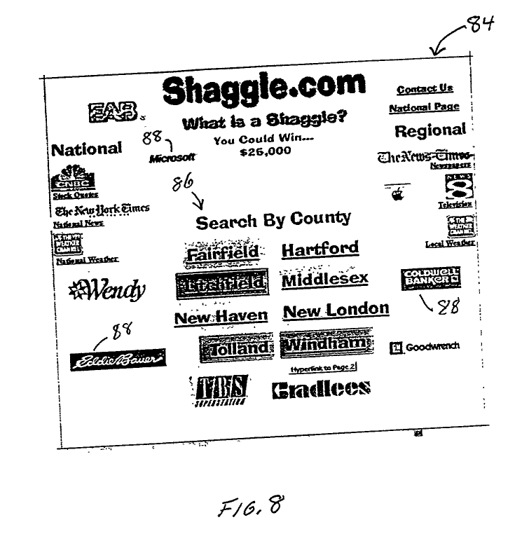

For a user selection of men's clothing, a web page 80 of FIG. 6 is then presented to user device 26. Web page 80 includes a group of logos 82 that are brands that indicate a source of men's clothing. Each logo 82 has an associated URL that hot-links the user to a web site or page of that source that is specific to men's clothing. Thus, if the user selects the Nordstrom logo, user device 26 is hot-linked to a web page or web site of the Nordstrom Company that is specific to men's clothing.

Thus, the logo search program and method of the present invention can locate an item and a source for such item with only three selections without being encumbered by a host of irrelevant items.

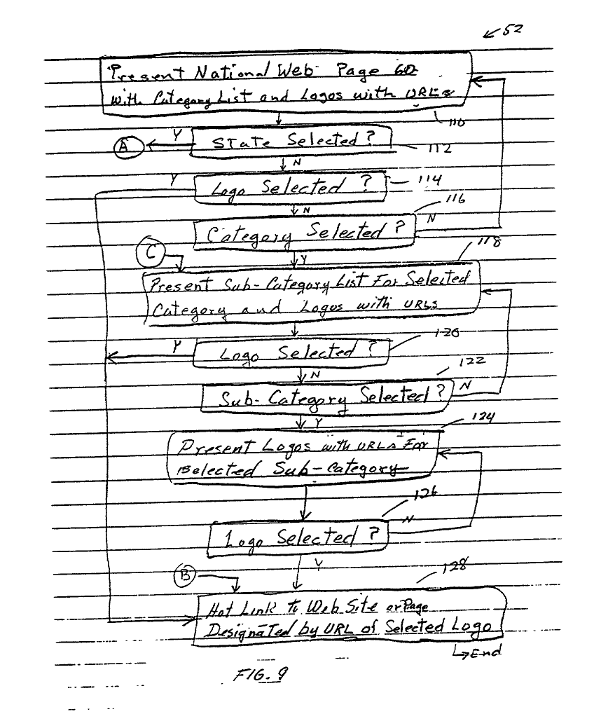

Another feature of the invention is that the user can tailor a search to a specific geographic region. For example, a territory can be divisible into nations, states or provinces, counties and so on. Referring again to FIG. 4 and to FIG. 7, geographical selector 64 enables a user to select a specific state in which the products of interest may be procured. As shown in FIG. 7, the user selects the state of Connecticut.

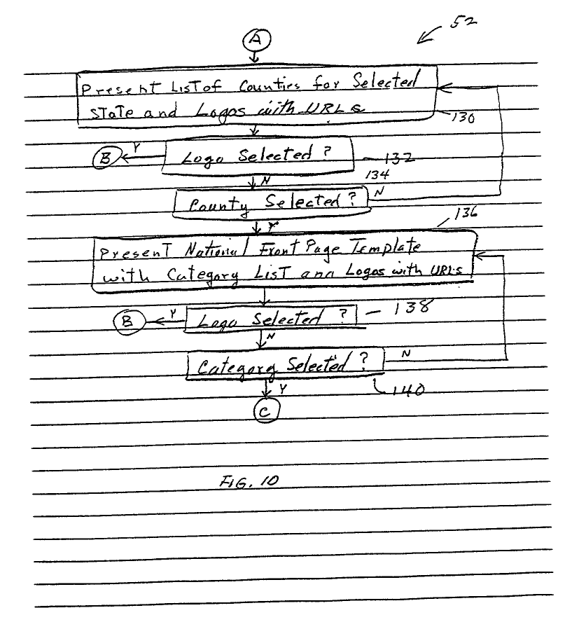

Referring to FIG. 8, a web page 84 is then presented to user device 26. Web page 84 includes a list 86 of counties and a group of logos 66. The user can select either a county of interest or a logo of interest. However, logos 66 are hot-linked to a corporate web site that may require substantial drilling to obtain a web page or site of specific interest. For a selection of a county, e.g., Fairfield County, web page 60 of FIG. 4 is presented to user device 26. Logos 66 may denote sources of national brands or of vendors located in Fairfield County. That is, a logo for Joe's Clothing Store in Danbury, Conn. may be presented as one of the logos 66. User selection of the Joe's Clothing Store logo will hot-link user device 26 to a web site of Joe's Clothing Store.

In a more general case, the item of interest may be selected from category list 62. Again, for a user selection of clothing, web page 70 is presented. For a user selection of men's clothing, web page 80 is presented. Each logo 88 is linked to a web site that identifies vendors of the selected logo that are located in Fairfield County, the vicinity thereof, the closest store thereto, or that are available for procurement from the web site.

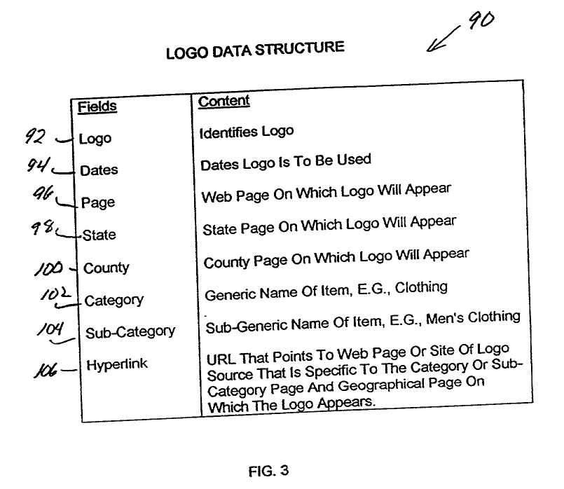

Referring to FIG. 3, there is shown a logo data structure 90 that is used by logo search program 52 (FIG. 2). Logo data structure 90 includes a logo field 92, a dates field 94, a page field 96, a state field 98, a county field 100, a category field 102, a sub-category field 104 and a hyperlink field 106. For example, logo field 92 identifies a specific logo. Dates field 94 identifies the dates the logo is to be displayed. Page field 96 identifies the web page upon which the logo is to appear. State field 98 identifies the territory for which the logo is to appear. For example, one value of state field can identify a nation and other values can identify states thereof. County field 100 identifies a county. Category field 102 identifies a generic class of items. Sub-category field 104 identifies a specific item. Hyperlink field 106 identifies the URL that links the logo identified by field 92 to a web site or page that is determined by the item identified by category or sub-category fields 102 and 104 and the geographical unit identified by state and/or county fields 98 and 102.

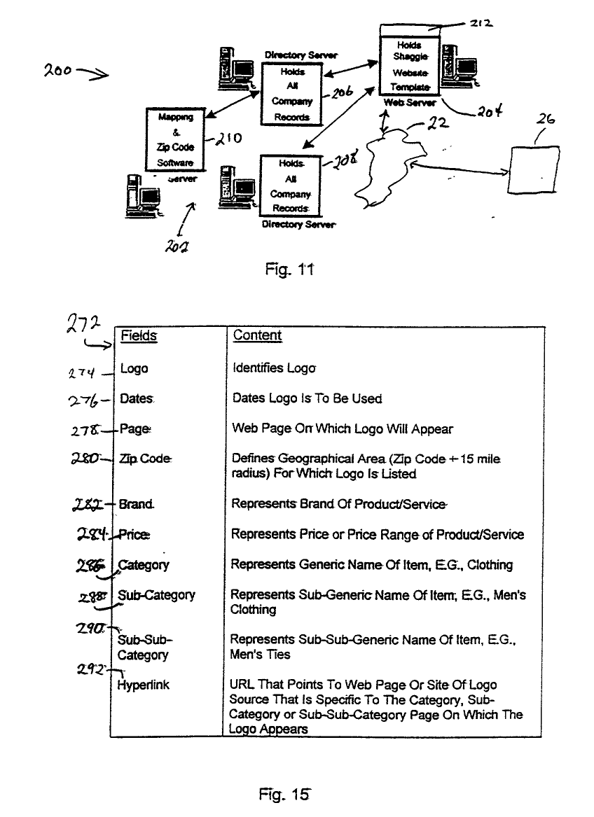

Referring to FIG. 9, logo search program 52 begins a session with a user device 26, for example, at step 110 by presenting web page 60 (FIG. 4). Step 112 determines if a state is selected. If yes, program 52 proceeds to a point A. If step 112 determines that a state is not selected, step 114 determines if a logo has been selected by user device 26. If yes, step 128 hot-links user device 26 to the web page identified by the URL associated with the selected logo.

If step 114 determines that a logo was not selected, step 116 determines if a category 62 has been selected. If no, steps 110 through 116 are repeated. If yes, step 118 presents a sub-category list for the selected category, such as web page 70 (FIG. 5). Step 120 then determines if a logo has been selected from web page 70 (if any logos appear thereon). If yes, step 128 is performed. If no, step 122 determines if a sub-category has been selected. If no, steps 118 through 122 are repeated. If step 122 determines that a sub-category has been selected, step 124 presents logos with URLs for the selected sub-category, such as appear on web page 80 (FIG. 6). Step 126 determines if a logo has been selected. If no, steps 124 and 126 are repeated. If yes, step 128 is performed and logo search program 52 ends the session.

If step 112 determines that a state is selected, logo program 52 continues with step 130 shown in FIG. 10. Step 130 presents a list of counties for the selected state as on web page 84 of FIG. 8. Step 132 determines if a logo has been selected. If yes, logo program 52 continues via point B to perform step 128 (FIG. 9). If no, step 134 determines if a county has been selected. If no, steps 130 through 134 are repeated. If yes, step 136 presents a category list and logos earmarked for the selected state and county. Step 138 then determines if a logo has been selected. If yes, logo program 52 continues via point B to perform step 128 (FIG. 9). If no, step 140 determines if a category has been selected. If no, steps 136 through 140 are repeated. If yes, logo search program 52 continues via a point C with steps 118 through 128 (FIG. 9).

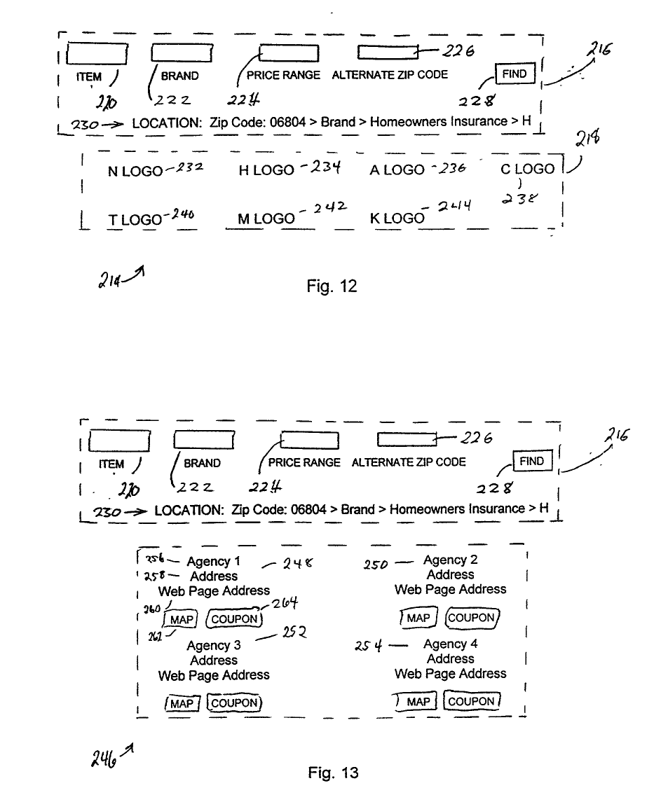

Referring to FIG. 11, an alternate embodiment of the present invention is shown as a web page server system 200. Web page server system 200 includes a plurality of servers 202 and a user device 26 that are interconnected by network 22. It will be apparent to those skilled in the art that although only one user device 26 is shown, more user devices can be interconnected to web servers 202 via network 22. Servers 202 include a web server 204, a directory server 206, a directory server 208 and a map and zip code server 210.

Web server 204 is substantially identical to web server 34A of FIGS. 1 and 2, except that a logo search program 212 replaces logo search program 52. Directory servers 206 and 208 hold the records of the advertising companies and participating vendors. Map and zip code server 210 holds mapping and zip code software. The mapping and zip code software is a known software that is capable of producing a map of a predetermined area defined by a zip code area and a specified radius or distance from the border of the zip code area. Servers 202 may communicate directly with one another as shown by the arrows or via connections (not shown) through network 22.

It will be apparent to those skilled in the art that the architecture of servers 202 is shown by way of example and that their functions can be performed by any number of servers, even a single server.

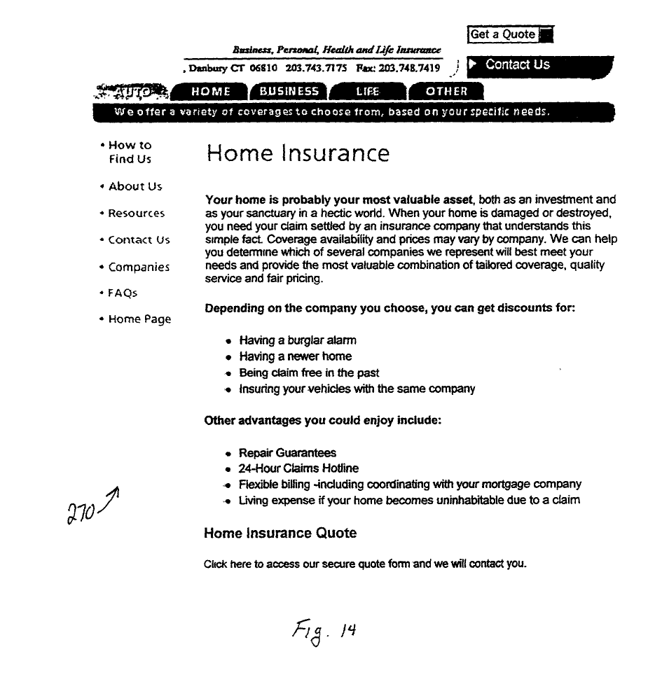

Logo search program 212 will initially be described based on a typical session with user device 26 of FIG. 11. In this session, a user desires to identify a vendor of home insurance in a specific area. With reference, to FIG. 12, logo search program initially presents a web page 214 to user device 26. Web page 214 includes a search definition area 216 and a logo select area 218. Search definition area 216 includes an item box 220, a brand box 222, a price range box 224, an alternate zip code box 226, a find button 228 and a search criteria line 230.

The user must identify a product by entering its name in item box 220. The user may enter a desired brand in brand box 222, but this is not necessary at this time. The user at this time may also enter a price range in price range box 226, but this is not necessary at this time. When the user connects to web server 204, logo search program 212 identifies the user's zip code from a previously registered cookie and enters the user's zip code in search selection line 230. If no previously registered cookie is available for the user, the user will be prompted by a drop down message (not shown) to enter a zip code in alternate zip code box 226. Alternate zip code box 226 can also be used by the user to override the default zip code selection. For example, the user may desire to find products in another location having a different zip code. As the user makes these entries, they are displayed in search criteria line 230.

By way of example, search criteria line 230 shows that the user has a zip code of 06804 and is interested in finding homeowners insurance in that area. The user has made no entries for price range or brand. If satisfied with these entries, the user clicks on find button 228.

Logo search program 212 then obtains from directory servers 206 and/or 208 the vendor data chains that match the criteria of home insurance for the zip code territory and the current date. Logo search program 212 then presents in logo search area 218 a plurality of logos of insurance companies that offer home insurance products/services in the territory defined by zip code 06804. In the illustrated example, the user selects H logo 234 with a mouse click.

Referring to FIG. 13, logo search program 212 then presents a web page 246 to user device 26. Web page 246 includes a local source area 248 and search definition area 216. Search definition area 216 can be used at this time to add a price range or change the zip code, if desired. Search selection line 230 now also lists the H logo. Local source area 246 includes a local source 248, a local source 250, a local source 252 and a local source 254. Local sources 248, 250, 252 and 254 contain substantially identical content. For example local source 248 includes a name 256 (agency 1), an address 258, a web page address 260, a map button 262 and a coupon button 264. Optionally, local source 248 may include a telephone and/or facsimile number. If desired, the user may click on map button 262 to view a map that shows the location of agency 1. If desired, the user may click on coupon button 264 to obtain a discount coupon that can be integrated into an online order, or printed out for presentation at the physical store of agency 1.

The user now has the option of selecting one of local sources 248, 252, 254 or 256. For the illustrated example, the user selects local source 248 by clicking thereon. Referring to FIG. 14, logo search program 212 then presents a web page 270 for agency 1 of local source 248. Alternatively, web page 270 may be presented via a hot link embedded in web page 246. Web page 270 presents several options for contacting agency 1.

Thus, logo search program 212 permits a user to reach the web page of a local vendor of desired products with a minimum of three clicks, namely, find button 228, H logo 234 and local source 248.

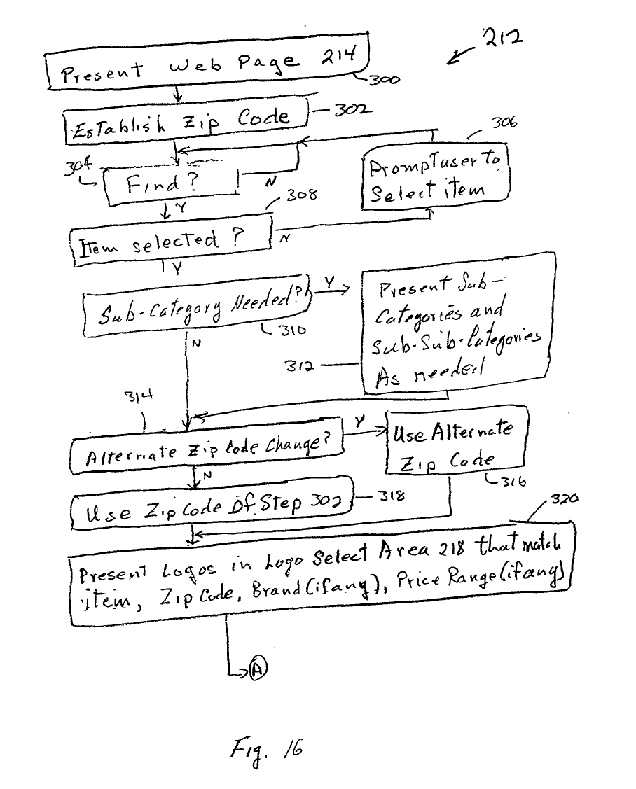

Referring to FIG. 15, there is shown a logo data structure 272 that is used by logo search program 212 (FIG. 11) for vendors who provide or sell products under a logo. Logo data structure 272 includes a logo field 274, a dates field 276, a page field 278, a zip code field 280, a brand field 282, a price field 284, a category field 286, a sub-category field 288, a sub-subcategory field 290 and a hyperlink field 292. For example, logo field 272 identifies a specific logo. Dates field 274 identifies the dates the logo is to be displayed. Page field 276 identifies the web page upon which the logo is to appear. Zip code field 280 identifies the territory for which the logo is to appear. For example, the territory is defined as the region that includes the zip code area plus a 15-mile zone beyond the border of the zip code area. Brand field 282 identifies the brand of a product offered by the vendor. Price field 284 identifies the price range of the product. Category field 286 identifies a generic class of items, e.g., insurance. Sub-category field 288 identifies a specific item, e.g., home insurance or a sub-generic class of items. For example, a generic class is clothing and a sub-generic class is men's clothing. Sub-sub-category field 290 identifies the specific product, e.g. men's ties. Hyperlink field 292 identifies the URL that links the logo identified by field 286, 288 or 290 to a web site or page that is determined by the item identified by category, sub-category or sub-sub-category fields 286, 288 or 290 and the territory defined by zip code field 280.

A vendor, e.g., local source 248 may register a catalog of products under the same brand or different brands. Optionally, the vendor may be given the opportunity to change the products in the catalog and/or their prices at any time on line. Optionally, logo search program 212 may present the catalog to the user upon selection of a hot button therefore, which may be located on web page 246 or 270.

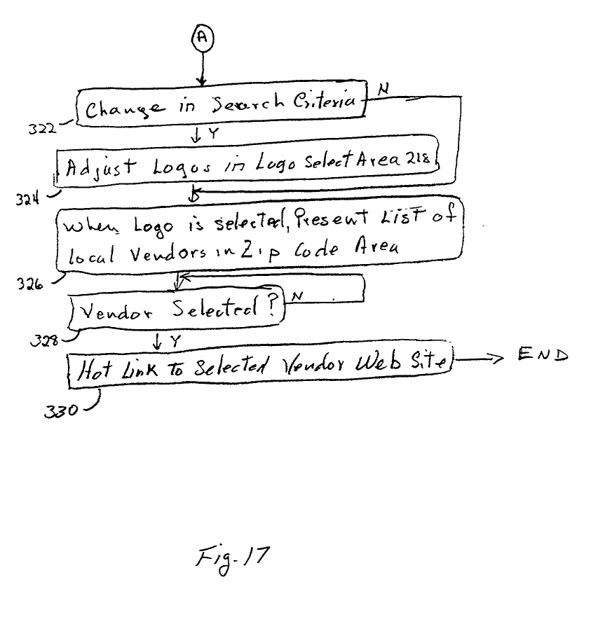

Referring to FIG. 16, logo search program 212 begins at step 300, which presents web page 214 to the user. Step 302 establishes a zip code for the user. If a cookie is on record for the user, the zip code in the cookie is used by default and displayed in search criteria line 230. If there is no cookie, step 302 will prompt the user as by a drop down message to enter a zip code in alternate zip code box 226. Step 304 determines if find button 228 has been selected. If not, step 304 is repeated until find button 228 is selected. After find button 228 is selected, step 308 determines if an item has been selected. If not, step 306 prompts the user to select an item and step 304 is repeated. When step 308 determines that an item has been selected, step 310 determines if a sub-category is needed. If so, step 312 presents subcategories, such as men's clothing, children's clothing, women's clothing and the like. If a sub-sub-category is needed, step 312 presents sub-subcategories, such as men's ties, men's suits, men's shirts and the like.

Step 314 is performed if step 310 determines that no sub-category is needed or when step 312 is finished. Step 314 determines if there has been an alternate zip code change. If so, step 316 sets the zip code to the current alternate zip code. If not, step 318 affirms that the zip code is the one established by step 302. Step 320 then presents logos in logo select area 218 that match the search criteria of zip code, item, sub-item (if any), brand (if any) and price range (if any). Logo program 212 then continues at A in FIG. 17.

Referring to FIG. 17, step 322 determines if there has been any change in the search criteria. If yes, step 324 adjusts the logos in logo select area 218 according to the changes. Step 326 is performed after step 324 or if step 322 determines that the search criteria have not been changed. Step 326 presents a list of local vendors who satisfy the search criteria. Step 328 determines if a vendor has been selected. If not, step 328 is repeated until a vendor is selected. Step 330 links the user to the selected vendor's web site. It will be apparent to those skilled in the art that hot links can be embedded on web page 216 so that by clicking on a desired vendor, the user is hot linked to the desired vendor's web site. For this case, steps 328 and 330 are not needed. Thus, the logo search program and method of the present invention can locate an item and a source for such item with only three selections or mouse clicks without being encumbered by a host of irrelevant items.

The present invention having been thus described with particular reference to the preferred forms thereof, it will be obvious that various changes and modifications may be made therein without departing from the spirit and scope of the present invention as defined in the appended claims. For example, the presentation of the sub-categories could be accomplished by dialog boxes, pop-up views and the like. In the embodiment of FIGS. 1-10, geographical selector 64 could appear on a web page that is separate from web page 60.

What is claimed is:

1. A method of searching for a source of a type of product comprising:
(a) presenting to a user a web page that includes a selection mechanism for identifying said product;
(b) in response to a user identification of said product, presenting a plurality of logos that each denote an associated source of said identified product, and
(c) in response to said user identifying one of said plurality of logos, presenting a list of sources that deal in said product of said associated source, and wherein at least one of said sources has a web site or web page that is hot-linked via a URL embedded in said list.

2. The method of claim 1, wherein said selection mechanism allows said user to identify a category of products, and further comprising (d) in response to said user identifying said category, presenting to said user the ability to identify a sub-category of said identified category, and wherein said identified sub-category is said product.

3. The method of claim 1, wherein said selection mechanism allows said user to identify a category of products, and further comprising (d) in response to said user identifying said category, presenting to said user the ability to identify a sub-category of said identified category, and (e) in response to said user identifying said sub-category, presenting to said user an ability to identify a sub-sub category of said sub-category, and wherein said identified sub-subcategory is said product.

4. The method of claim 1, wherein said selection mechanism also identifies a predetermined territory, and wherein said sources are located in said predetermined territory.

5. The method of claim 4, wherein said predetermined territory is defined as an area of a zip code that has an extended border.

6. The method of claim 5, wherein said zip code is determined by a cookie.

7. The method of claim 5, wherein said zip code is entered by said user.

8. The method claim 4, wherein said selection mechanism includes an ability for said user to define said predetermined territory by a member of the group consisting of: country, state and county.

9. A computer that conducts an online session with a user for identifying a type of product, comprising:
first means for presenting to said user a web page that includes a selection mechanism for identifying said product;
second means, responsive to identification by said user of said product, for presenting a plurality of logos that each denote an associated source of said identified product, and
third means, responsive to said user identifying one of said plurality of logos, for presenting a list of sources that deal in said product of said associated source, and wherein at least one of said sources has a web site or web page that is hot-linked via a URL embedded in said list.

10. The computer of claim 9, wherein said selection mechanism allows said user to identify a category of products, and further comprising: fourth means, responsive to said user identifying said category, for presenting to said user the ability to identify a sub-category of said identified category, and wherein said identified sub-category is said product.

11. The computer of claim 9, wherein said selection mechanism allows said user to identify a category of products, and further comprising: fifth means, responsive to said user identifying said category, for presenting to said user the ability to identify a sub-category of said identified category, and sixth means, responsive to said user identifying said sub-category, for presenting to said user an ability to identify a sub-sub category of said sub-category, and wherein said identified sub-sub-category is said product.

12. The computer of claim 9, wherein said selection mechanism also identifies a predetermined territory, and wherein said sources are located in said predetermined territory.

13. The computer of claim 12, wherein said predetermined territory is defined as an area of a zip code that has an extended border.

14. The computer of claim 13, wherein said zip code is determined by a cookie.

15. The computer of claim 12, wherein said zip code is entered by said user.

16. The computer of claim 12, wherein said selection mechanism includes an ability for said user to define said predetermined territory by a member of the group consisting of: country, state and county.

17. A memory media for operating a computer that conducts a searching session with a user for identifying a product, comprising.
first means for operating said computer to perform a first operation that presents to said user a web page that includes a selection mechanism for identifying said product;
second means for operating said computer to perform a second operation that, responsive to identification by said user of said product, presents a plurality of logos that each denote an associated source of said identified product, and
third means for operating said computer to perform a third operation that, responsive to said user identifying one of said plurality of logos, presents a list of sources that deal in said product of said associated source, and wherein at least one of said sources has a web site or web page that is hot-linked via a URL embedded in said list.

18. The memory media of claim 17, wherein said selection mechanism allows said user to identify a category of products, and further comprising: fourth means for operating said computer to perform a fourth operation that, responsive to said user identifying said category, presents to said user the ability to identify a sub-category of said identified category, and wherein said identified sub-category is said product.

19. The memory media of claim 17, wherein said selection mechanism allows said user to identify a category of products, and further comprising: fifth means for operating said computer to perform a fifth operation that, responsive to said user identifying said category, presents to said user the ability to identify a sub-category of said identified category, and sixth means for operating said computer to perform a sixth operation that, responsive to said user identifying said sub-category, presents to said user an ability to identify a sub-sub category of said sub-category, and wherein said identified sub-subcategory is said product.

20. The memory media of claim 17, wherein said selection mechanism also identifies a predetermined territory, and wherein said sources are located in said predetermined territory.

21. The memory media of claim 20, wherein said predetermined territory is defined as an area of a zip code that has an extended border.

22. The memory media of claim 21, wherein said zip code is determined by a cookie.

23. The memory media of claim 20, wherein said zip code is entered by said user.

24. The memory media of claim 20, wherein said selection mechanism includes an ability for said user to define said predetermined territory by a member of the group consisting of: country, state and county.
